(19) United States
(12) Patent Application Publication
(10) Pub. No.: US 2003/0121060 A1
(43) Pub. Date: Jun. 26, 2003

(54) Network configuration management with proximity keys

(76) Inventor: Stanley A. McClellan, Allen, TX (US)

Correspondence Address: CONLEY ROSE, P.C., P. O. BOX 3267, HOUSTON, TX, 77253-3267, US

(21) Appl. No.: 10/036,143

(22) Filed: Dec. 26, 2001

(51) Int. Cl. H04N 7/16

(52) U.S. Cl. 725/153

(57) ABSTRACT

A method and apparatus for managing the configuration of telecommunications networks and/or computer networks with proximity keys. A proximity key can be embedded in or removably coupled to a cable. Data can be stored in the key that uniquely identifies the cable to which the key is attached. A proximity key reader can be placed on a network device or in a portable device. A reader coupled to a network device can contain information that identifies the device to which it is attached. When the proximity key on the cable and the proximity key reader are brought near each other the reader reads the data in the key. A control unit can use the cable and device identification data to confirm a proper connection between a cable and a device and to document which devices are connected by which cables.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention generally relates to the interconnection of devices in telecommunications networks and computer networks and more particularly to a method and apparatus for identifying the devices and cables in a network through the use of proximity keys.

2. Background of the Invention

Telecommunications networks and computer networks often contain multiple devices connected by multiple cables. When large numbers of network devices are present, the configuration of devices and interconnecting cables can become highly complex. This can cause difficulty in the installation of new devices and in the maintenance of a network. When a new device is added to a network, a large number of other devices may exist into which the cable attached to the new device could be connected. Finding the proper connection point can be difficult. In addition, the determination of which devices are connected to which other devices becomes increasingly difficult as the complexity of the system increases. For example, a technician replacing a faulty cable may not be able to determine, merely by visual inspection, which devices the cable is attached to.

Several methods exist for discovering and/or keeping track of which cables connect which network devices. In one technique, technicians apply an electrical or optical signal to one end of a cable and then test the ends of all other cables to find the one on which the applied signal is present. This method can be very time-consuming in networks containing large numbers of cables.

Another approach to correlating cables and devices is to manually label each end of every cable in a network and each device in the network with a serial number or other identifying mark. When a cable is connected to a device, the information on the cable and device labels is manually recorded and placed in a database that documents which devices are connected by which cables. When technicians wish to determine which cables connect which devices, they can search the database for the desired information. When devices or cables are replaced, the database must be manually updated.

These conventional approaches for documenting cable and device connections are labor-intensive, time-consuming, and prone to human errors. Significant down time can occur while technicians research which devices are connected by which cables and/or verify that the cables and devices are properly connected.

### BRIEF SUMMARY OF THE INVENTION

The present invention provides an automated way to identify cables and/or to obtain information about the cables. An embodiment of the cable identification system comprises a proximity key coupled to a cable. Information regarding the type of cable to which the key is coupled may be stored in the key. Other information that can be stored in the key includes the devices that can be connected by the cable. Information can be stored in the key at the time of manufacture of the key or after the time of manufacture of the key. The key can be made an integral part of the cable at the time of manufacture of the cable or can be coupled to the cable after the time of manufacture of the cable. In another embodiment, the cable identification system may also comprise a proximity key reader for reading the information from the proximity key. The key reader can be part of a portable instrument or can be coupled to a network device. The key reader typically sends information to a control unit. In an embodiment, a signal can indicate a proper connection of the cable to the network device. The signal can be visual or non-visual. Visual signals can be coupled to the proximity key, to the proximity key reader, or to the network device.

In another embodiment, the cable identification process typically comprises the receiving of cable information by a proximity key reader from a proximity key coupled to a cable. The information received from the key can be used to identify the cable, determine the proper connection of the cable to a network device, and/or determine the proper connection of the opposite end of the cable to a network device. The information received from the key can also be stored in a database, initiate communication between the two ends of the cable, and/or perform network documentation and configuration tasks.

### DESCRIPTION OF THE DRAWINGS

For a detailed description of the preferred embodiments of the invention, reference will now be made to the accompanying drawings in which:

FIG. 1 is a schematic drawing of an embodiment of a cable identification system in accordance with the present invention;

FIG. 2 is a schematic drawing of another embodiment of a cable identification system in accordance with the present invention;

FIG. 3 is a schematic drawing of another embodiment of a cable identification system in accordance with the present invention;

FIG. 4 is a schematic drawing of another embodiment of a cable identification system in accordance with the present invention;

FIG. 5 is a schematic drawing of another embodiment of a cable identification system in accordance with the present invention; and

FIG. 6 is a flowchart of typical steps in the use of a cable identification system in accordance with the present invention.

### NOTATION AND NOMENCLATURE

Certain terms are used throughout the following description and claims to refer to particular system components. As one skilled in the art will appreciate, components may be referred to by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect connection via other devices and connections. For purposes of this specification, the term device or network device includes any hardware component of a telecommunications and/or electronic computer network such as a telecommunications switch, a network server, a client computer, or a peripheral device such as a printer or external data storage device attached to a computer. The term cable includes any physical means of interconnecting devices such as fiber optic cables and various types of electrically conducting wires including coaxial cables and twisted-pair cables such as Category 5 cables.

### DETAILED DESCRIPTION OF EMBODIMENTS

The invention relates to a method and apparatus for identifying and/or obtaining information about the devices and cables in a telecommunications network and/or computer network through the use of proximity keys. A proximity key is a component of a commercially available system that can be referred to as a proximity switch. Other components of a proximity switch typically include a proximity key reader and a microprocessor-based control unit. The proximity key contains electronically encoded data that can be read by the proximity key reader. Proximity switches are commonly used in security applications as an electronic means for locking and unlocking doors. In a typical use of a proximity switch, a proximity key is held near a proximity key reader at a door or gate leading to a secure area such as a parking garage or a hotel room. The reader reads the data embedded in the card and sends the data to the control unit. The control unit then unlocks the door or opens the gate if the data indicates the key-holder is authorized to enter the area.

Another application for proximity switches is in the automatic deduction of a fee or the amount of a purchase from the account of a key-holder. For example, a customer can place a proximity key near a reader on a gasoline pump. The reader reads the data in the key and sends the data to a control unit. The control unit can then authorize a purchase and turn on the gas pump. When the customer turns the gas pump off, the control unit automatically records the purchase price in the customer's account. In another example, a proximity key can be placed on the windshield of an automobile and a reader can be placed at a toll booth on a toll road. As the automobile passes through the booth the reader reads the customer's account information from the key and automatically records the toll in the customer's account.

Proximity switches typically operate through the exchange of radio frequency signals between the reader and the key. The reader emits a radio frequency (RF) signal that extends a short distance from the reader. The key is a transponder comprising an antenna and an integrated circuit (IC). The IC is electronically programmed with data that uniquely identifies the key. When the key is brought near the reader, the RF signal from the reader energizes the IC through induction. The energized IC then places on the antenna a voltage pattern corresponding to the identification data embedded in the IC. This voltage pattern is transmitted from the antenna in the key to an antenna in the reader. The reader is able to interpret the voltage pattern as the key's identification data.

The reader typically passes the key's identification data to a control unit. In a large installation with multiple readers, the control unit can be a stand-alone computer with inputs from each reader. In an installation with only a small number of readers, the reader and the control unit might be integrated into a single instrument. In either case, the control unit is capable of initiating the appropriate actions based on the data received by the reader from the key, such as unlocking a door, opening a gate, or adjusting a customer's account.

In an embodiment of the present invention, proximity switches can be used to identify which cables are connected to which devices in a telecommunications network or computer network. While numerous configurations are possible, typical embodiments involve placing a proximity key on a cable. The information in the proximity key uniquely identifies the cable on which it is placed. Other information can also be embedded in the proximity key such as the types of devices to which each end of the cable can be connected. When the cable is brought near a proximity key reader, the reader reads the information on the proximity key. This information can then be used in numerous network configuration management and documentation tasks such as building a database of network devices and connections, initiating communication between network devices, or assembling a diagram of the network.

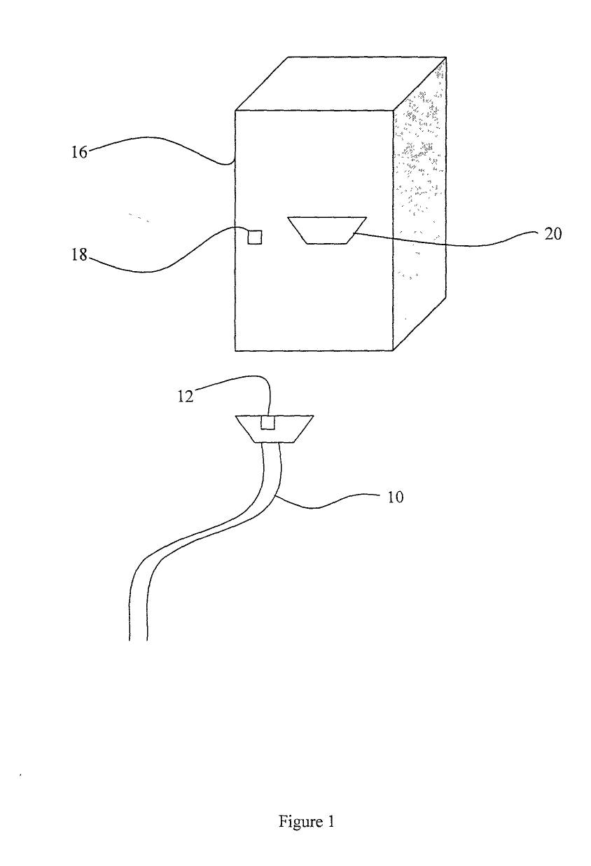

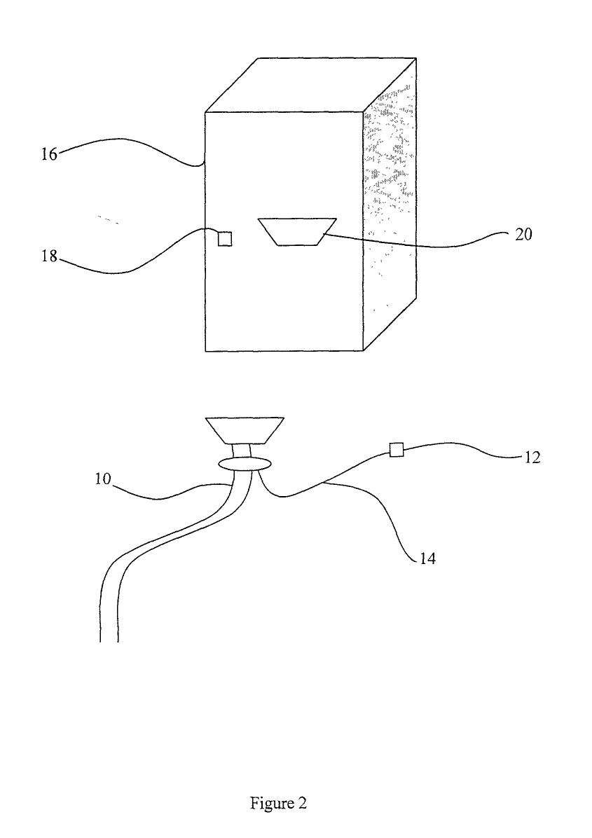

In one embodiment, a proximity key is embedded in or otherwise made an integral part of the cable at the time of manufacture of the cable. This embodiment is illustrated in FIG. 1 where a proximity key 12 is embedded in a cable 10. In another embodiment, the key is an after market addition that can be removably attached to the cable by means of a lanyard or other coupling mechanism. This is shown in FIG. 2 where a proximity key 12 is attached to a cable 10 by a lanyard 14.

The proximity key reader can be embodied in a portable device. A technician wishing to identify a cable can bring the portable reader and the cable close enough to each other that the proximity key on the cable receives the signal emitted by the reader and sends its information to the reader. In one embodiment, the portable device can contain both a reader and a control unit. This would allow the control unit to provide immediate feedback to the technician as to the identity of the cable. In another embodiment, the cable information can be stored in the portable device and downloaded to a separate control unit at a later time.

Alternatively, a reader can be attached to a network device near a cable connection point. When a cable is plugged in to the connection point, the proximity key on the cable sends the cable's information to the reader at the connection point and the reader can then send this information to a control unit. The reader can be embedded with information that uniquely identifies the reader and this identification information can be correlated with the cable connection point near which the reader is attached. In addition to sending cable information, the reader can also send its own identification information to the control unit when a cable is plugged in. In this manner, the control unit receives information regarding which cables are plugged in to which connection points on which network devices. This configuration is illustrated in FIG. 1. A proximity key 12 is embedded in a cable 10. A proximity key reader 18 is placed on a network device 16 near a connection point 20.

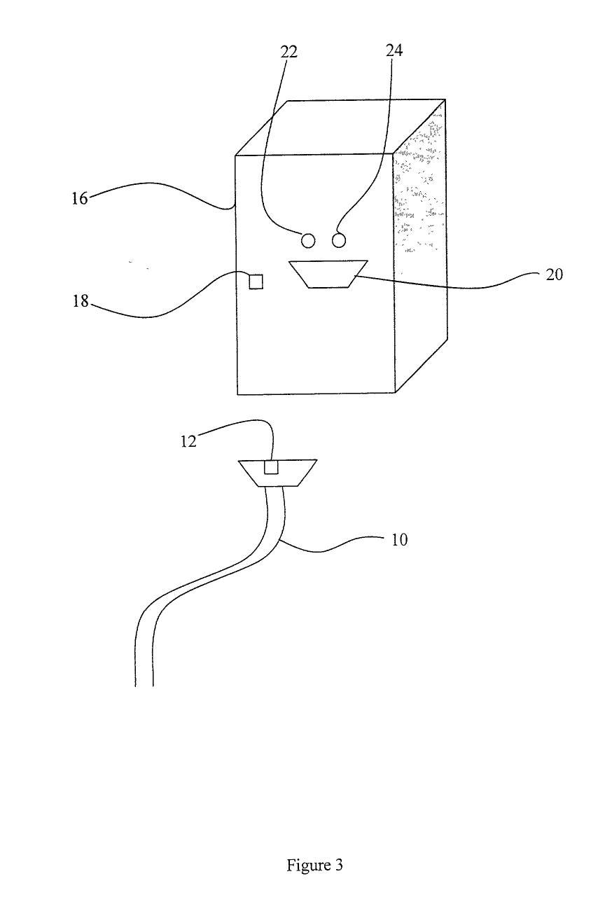

When information is embedded in both the proximity key on a cable and the key reader on a network device, the capability exists for decisions to be made regarding whether the correct cable has been or is about to be connected to the correct device. For example, when a cable is brought near a connection point, information about the cable and connection point can be sent to a control unit. The control unit can contain software or logic circuitry that determines whether the cable is appropriate for the connection point. Factors that can determine whether a cable is appropriate for a particular connection point might include the type of cable, the type of connection point, and the device to which the other end of the cable is connected. When a cable is about to be plugged in to a connection point, the control unit can activate an audible, visual, or other signal confirming the proper connection. For example, a light on or near the key, the reader, or the network device can either warn that an inappropriate cable is about to be connected or confirm that the cable is acceptable. Similarly, a non-visual signal, such as an audible tone, might be emitted to provide notification of whether the cable is appropriate for the connection point. An embodiment of such a network device, using notification lights, is shown in FIG. 3. Lights 22 and 24 are placed on the network device 16 near the proximity key reader 18 and the connection point 20. Light 22 could be a green colored light to indicate a proper connection and light 24 could be a red colored light to warn of an improper connection.

Information can be stored or programmed into the proximity keys at the time of manufacture of the cables or after the manufacture of the cables. Field programmability, the capability of storing information in a key after the time of manufacture, would give users the capability to change the cable identification data as necessary as well as to include additional information in the key such as which devices should be connected by which cables. Field programmability would provide additional flexibility and functionality in network configuration and documentation. An electrically erasable programmable read only memory device (EEPROM) or a similar device could be placed in a proximity key to retain field programmed information.

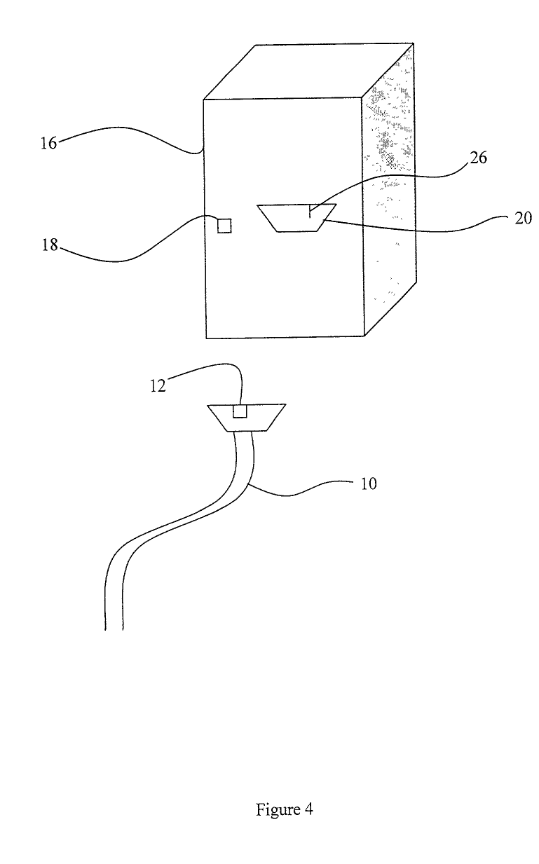

In an additional embodiment, the integrated circuit in the proximity key can receive its power from a network device. With this configuration the integrated circuit is not energized through induction as is typically the case. Instead, when a cable containing a proximity key is attached to a network device, a pin in the connection point to which the cable is attached provides energy to the integrated circuit. The integrated circuit then activates an antenna which transmits cable information to a reader in the manner described above or otherwise transmits the information to the reader. This embodiment is illustrated in FIG. 4. A pin 26 is present in the connection point 20 on the network device 16. The pin 26 can provide power to the proximity key 12 on the cable 10. Alternatively, the cable information could be transmitted to the reader or the control unit via other pins in the connector.

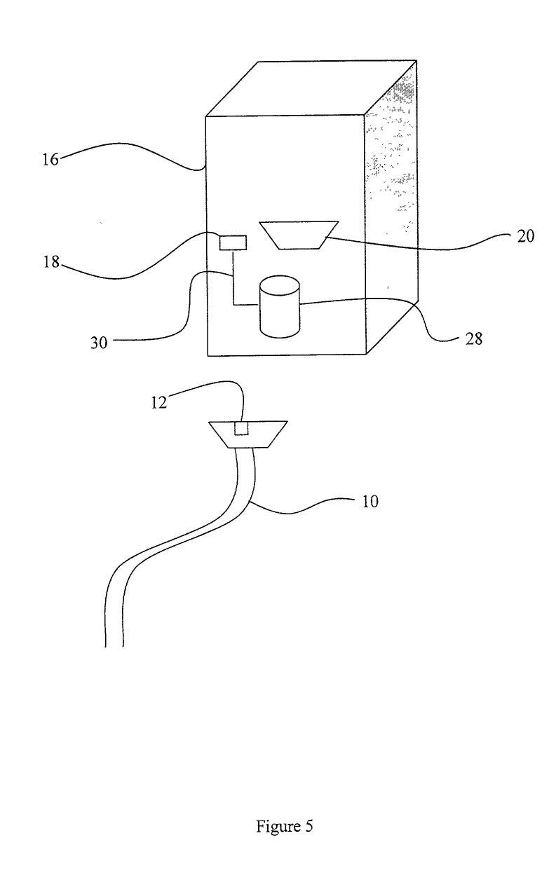

Proximity switches used in identifying cables in a network can include a control unit as well as the proximity key and proximity key reader. The control unit is typically a software-based tool that receives and stores the information from the reader. It can use the information collected from the network devices and cables to determine whether the proper cable is connected to the proper device as described above. The control unit can also perform various other tasks such as automatically assembling a map or diagram of the network. In an alternative embodiment, the control unit retains the data in a database that documents the devices, cables, and connections in the network. Users can access the database to perform queries regarding the connections in the network. In addition, the control unit can initiate communications between the two ends of a cable so that each end is aware of the device to which the other end is connected. An embodiment in which a control unit is internal to a network device is shown in FIG. 5. When proximity key reader 18 on device 16 receives cable information from proximity key 12, the reader 18 sends the information to control unit 28 within device 16 via connection 30. In an alternative embodiment, a control unit can be located externally to a network device. In this case, the reader might send information directly to the control unit via a cable or might send the information to a circuit board or other intermediary apparatus which in turn sends the information to the control unit.

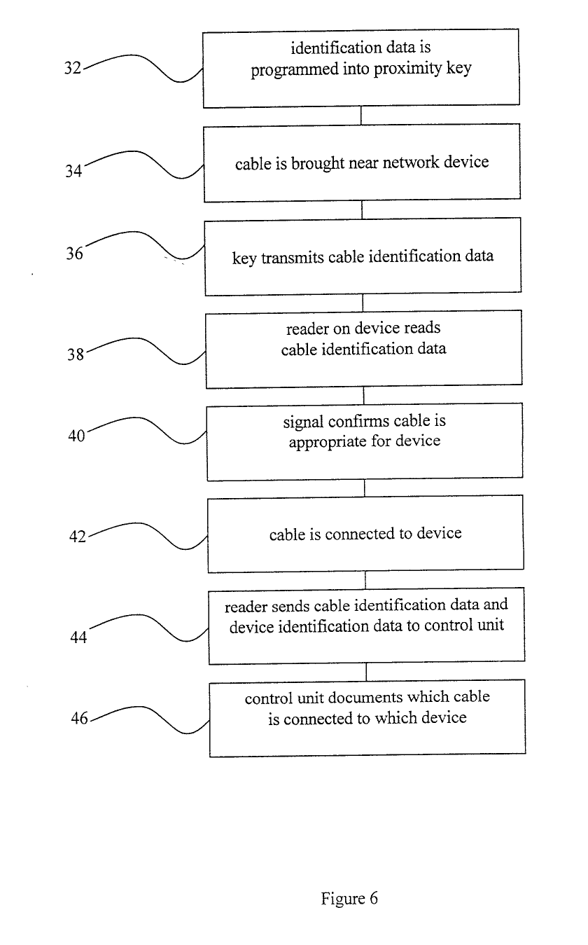

FIG. 6 depicts an embodiment of the method of using proximity keys to identify cables. In block 32, identification data is programmed into a programmable proximity key coupled to a cable. In block 34, the cable is brought near a network device. In block 36, the key transmits cable identification data to a proximity key reader on the device. In block 38, the reader on the device reads the cable identification data. In block 40, a signal confirms that the cable is appropriate for the device. In block 42, the cable is connected to the device. In block 44, the reader sends the cable identification data and device identification data to a control unit. In block 46, the control unit documents which cable is connected to which device or performs some other action in response to the data received from the key.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A cable identification system comprising:
a cable; and
a proximity key coupled to said cable storing information regarding the cable.

2. The system of claim 1 wherein the information stored by the key identifies the type of cable.

3. The system of claim 1 wherein the information stored by the key identifies the devices that can be connected by the cable.

4. The system of claim 1 wherein the proximity key is an integral part of the cable.

5. The system of claim 1 wherein the proximity key is removably coupled to the cable.

6. The system of claim 1 wherein data is stored in the key at the time of manufacture.

7. The system of claim 1 wherein data is stored in the key after the time of manufacture.

8. The system of claim 7 wherein data is stored in an EEPROM on the key.

9. The system of claim 1 further comprising a proximity key reader for reading the information from the proximity key.

10. The system of claim 9 wherein a portable instrument contains the proximity key reader.

11. The system of claim 9 wherein the proximity key reader is coupled to a network device.

12. The system of claim 9 wherein the proximity key reader sends information read from the proximity key to a control unit.

13. The system of claim 9 further comprising a signal indicating proper connection of the cable.

14. The system of claim 13 wherein the signal is a visual signal.

15. The system of claim 14 wherein the visual signal is coupled to the proximity key.

16. The system of claim 14 wherein the visual signal is coupled to the proximity key reader.

17. The system of claim 14 wherein the visual signal is coupled to the network device.

18. A method for managing cables comprising:
receiving cable information from a proximity key coupled to a cable.

19. The method of claim 18 further comprising identifying the cable using the information received from the proximity key.

20. The method of claim 18 further comprising determining the proper connection of the cable to a network device based on the information received from the proximity key.

21. The method of claim 18 further comprising determining the proper connection of the opposite end of the cable to a network device based on the information received from the proximity key.

22. The method of claim 18 further comprising storing the information in a database.

23. The method of claim 18 further comprising initiating communication between the two ends of the cable based on the information received from the proximity key.

24. The method of claim 18 further comprising performing network documentation tasks based on the information received from the proximity key.

25. The method of claim 18 further comprising performing network configuration tasks based on the information received from the proximity key.

26. A cabling system comprising:
means for receiving cable information from a proximity key coupled to a cable.

27. The system of claim 26 further comprising means for identifying the cable based on the information received from the proximity key.

28. The system of claim 26 further comprising means for determining the proper connection of the cable to a network device based on the information received from the proximity key.

29. The system of claim 26 further comprising means for determining the proper connection of the opposite end of the cable to a network device based on the information received from the proximity key.

30. The system of claim 26 further comprising means for storing the information in a database.

31. The system of claim 26 further comprising means for initiating communication between the two ends of the cable based on the information received from the proximity key.

32. The system of claim 26 further comprising means for performing network documentation tasks based on the information received from the proximity key.

33. The system of claim 26 further comprising means for performing network configuration tasks based on the information received from the proximity key.
